(19) United States
(12) Patent Application Publication
(10) Pub. No.: US 2017/0278203 A1
(43) Pub. Date: Sep. 28, 2017

(54) SYSTEM AND METHOD FOR PREDICTIVE RESTAURANT TABLE REQUEST FULFILLMENT WITH CONCURRENT FOOD CHOICE PREPARATION

(71) Applicant: Rockspoon, Inc., San Jose, CA (US)

(72) Inventor: Nagib Georges Mimassi, Palo Alto, CA (US)

(21) Appl. No.: 15/478,230

(22) Filed: Apr. 3, 2017

Related U.S. Application Data
(63) Continuation-in-part of application No. 15/478,218, filed on Apr. 3, 2017.
Application No. 15/478,218 is a continuation-in-part of application No. 15/333,158, filed on Oct. 24, 2016.
Application No. 15/333,158 is a continuation-in-part of application No. 15/278,033, filed on Sep. 28, 2016.
Application No. 15/278,033 is a continuation-in-part of application No. 15/241,079, filed on Aug. 19, 2016.
Application No. 15/241,079 is a continuation-in-part of application No. 15/221,531, filed on Jul. 27, 2016.
(60) Provisional application No. 62/321,212, filed on Apr. 12, 2016.
(60) Provisional application No. 62/317,632, filed on Apr. 4, 2016.
(60) Provisional application No. 62/399,331, filed on Sep. 23, 2016.
(60) Provisional application No. 62/313,704, filed on Mar. 25, 2016.
(60) Provisional application No. 62/313,696, filed on Mar. 25, 2016.
(60) Provisional application No. 62/313,693, filed on Mar. 25, 2016.

(51) Int. Cl. G06Q 50/12; G06Q 30/06; G06Q 10/02

(52) U.S. Cl. CPC G06Q 50/12; G06Q 10/02; G06Q 30/0635

(57) ABSTRACT

A system and method for predictive restaurant table request fulfillment with concurrent food choice preparation has been developed. The invention makes use of multiple factors such as type of restaurant, time of day, menu items ordered and previous eating speed characteristics to predict when table within a restaurant will become vacant. This capability is used to predict table vacancy at given future time points allowing patrons to make very short notice, next table available requests remotely and be notified with pre-specified lead time when their table becomes available. Food preparation time tracking enables menu item delivery at time of patron seating.

### CROSS-REFERENCE TO RELATED APPLICATIONS

The present application claims the benefit of, and priority to, U.S. provisional patent application Ser. No. 62/321,212, titled “SYSTEM AND METHOD FOR PREDICTIVE RESTAURANT TABLE REQUEST FULFILLMENT WITH CONCURRENT FOOD CHOICE PREPARATION ” and filed on Apr. 12, 2016, and is also a continuation-in-part of U.S. patent application Ser. No. 15/478,218, titled “ PREDICTIVE RESTAURANT TABLE MANAGEMENT” and filed on Apr. 3, 2017, which claims the benefit of, and priority to, U.S. provisional application Ser. No. 62/317,632, titled “SYSTEM AND METHOD FOR PREDICTIVE RESTAURANT TABLE MANAGEMENT”, and filed on Apr. 4, 2016, which is also a continuation-in-part of U.S. application Ser. No. 15/333,158, titled “AUTOMATED PATRON FOOD TAKE-OUT MANAGEMENT” and filed on Oct. 24, 2016, which claims the benefit of, and priority to, U.S. provisional patent application Ser. No. 62/399,331, titled “AUTOMATED PATRON FOOD TAKE-OUT MANAGEMENT” and filed on Sep. 23, 2016, and is also a continuation-in-part of U.S. application Ser. No. 15/278,033, titled “PROXIMITY-BASED PATRON DISCOVERY AND GROUP CREATION” and filed on Sep. 28, 2016, which claims the benefit of, and priority to, U.S. provisional patent application Ser. No. 62/313,704, titled “PROXIMITY-BASED PATRON DISCOVERY AND GROUP CREATION” and filed on Mar. 25, 2016, and is also a continuation-in-part of U.S. patent application Ser. No. 15/241,079, titled “PROXIMITY-BASED PATRON RELATIONSHIP MANAGEMENT” and filed on Aug. 19, 2016, which claims the benefit of, and priority to, U.S. provisional application Ser. No. 62/313,696, titled “PROXIMITY-BASED CUSTOMER RELATIONSHIP MANAGEMENT”, and filed on Mar. 25, 2016, which is also a continuation-in-part of U.S. application Ser. No. 15/221,531, titled “AUTOMATED PATRON IDENTIFICATION AND COMMUNICATION MANAGEMENT” and filed on Jul. 27, 2016, which claims the benefit of, and priority to, U.S. provisional patent application Ser. No. 62/313,693, titled “AUTOMATED CUSTOMER IDENTIFICATION SYSTEM” and filed on Mar. 25, 2016, the entire specification of each of which is incorporated herein by reference in its entirety.

### BACKGROUND OF THE INVENTION

Field of the Invention

The present invention is in the field of restaurant operations management solutions, specifically the area of predictive table request fulfillment with concurrent food choice preparation.

Discussion of the State of the Art

Restaurant operations management, while changed significantly over the past decade by technology, has not kept pace with the electronics revolution that is currently underway. Fulfillment of table requests still relies on reaction to patrons physically vacating their tables which results in inefficient turnover, lower table occupancy and suboptimal numbers of patron being served.

Much of a restaurant's business results from walk-in patrons requesting tables. Currently, when tables are not immediately available patrons are largely forced to wait at the restaurant entrance or another waiting area within the restaurant either listening for their name to be called over the background noise or while holding a pager device. Either way, patrons are tied to remaining within or in very close proximity to the restaurant for what can be a significant length of time. Once seated, customers must then place their order and wait, possibly again, for the chosen food to be prepared, a time period that is often described negatively by patrons in their review of restaurants.

What is needed is a system and method that allows the efficient use of a restaurant's tables through accurate predictive occupancy determination. What is further needed is a system and method that uses this predictive table occupancy determination in the fulfillment of both traditional long lead time table reservation requests and for immediate, next available table, type requests but where the patron making the request is not required to wait for long periods of time within or in close proximity to the restaurant and is alerted, with pre-specified lead time, when their table is available. Last, what is needed is a system and method for a patron to pre-order menu items for themselves and their party and have those items arrive all at once and in optimal enjoyment condition shortly after they are seated at their table.

### SUMMARY OF THE INVENTION

The inventor has developed a system and method for predictive restaurant reservation fulfillment that uses various data collected during restaurant operations, combined with programming logic that allows the embodiments to accurately predict a restaurant's table occupancy and to use those predictive data to assign tables during table reservation creation by patrons. The embodiment also tracks accurate menu item food preparation time data which, when combined with the predictive table occupancy capabilities, allows a patron to remotely reserve a table at the restaurant on very short notice in a next table available manner where that patron is alerted when table availability is imminent and then have desired, pre-ordered menu items served shortly after the patron's party is seated. This is in addition to table reservation with more traditional lead times but with the capability to have pre-ordered menu items served shortly after patron party arrival.

According to a preferred embodiment, a system for allowing a restaurant patron to reserve a table and order food items, to be served shortly after seating, comprising: a restaurant portal software application stored in a memory of and operating on a processor of a computing device, a restaurant reservations processing module stored in a memory of and operating on a processor of a computing device. The restaurant portal software application: runs on a mobile computing device, laptop or workstation of the restaurant patron, acts as an interface between the restaurant patron and a restaurant; allows the restaurant patron to create a table reservation request, allows the restaurant patron to place an order of food items to be served shortly after the restaurant patron arrives at the table. The restaurant reservations processing module: receives the restaurant patron's table reservation request, receives a current list of predictively available tables by time point, assigns the table from the current list of predictively available tables to the restaurant patron's table reservation request, may receive the order of food items data to be served at the table from the restaurant patron, updates the current list of predictively available tables to remove the table, confirms all reservation related information with the patron, accesses a list of food preparation times for all menu items served by the restaurant, at the prescribed time points prior to restaurant patron's arrival, submits the order of food item data for preparation and service just after the restaurant patron is seated at the table.

According to another preferred embodiment, a method to allow a restaurant patron to reserve a table and order food items, to be served shortly after seating, the method comprising the steps of: (a) use a restaurant portal software application on a computing device of a restaurant patron to reserve a table and to pre-order food; (b) use an up-to-date list of restaurant tables predicted to be available assign an available to the restaurant patron's reservation; (c) retrieve food item preparation time data for menu items ordered during reservation process; and (d) use food item preparation time and table reservation time to coordinate service of pre-ordered food shortly after the restaurant patron is seated.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way

FIG. 1 is a block diagram illustrating an exemplary hardware architecture of a computing device used in various embodiments.

FIG. 2 is a block diagram illustrating an exemplary logical architecture for a client device, according to various embodiments.

FIG. 3 is a block diagram illustrating an exemplary architectural arrangement of clients, servers, and external services, according to various embodiments.

FIG. 4 is a block diagram illustrating an exemplary overview of a computer system as may be used in any of the various locations throughout the system

FIG. 5 is a diagram of an exemplary architecture of system for predicting restaurant table occupancy according to an embodiment.

FIG. 6 is a diagram of a method to allow reservation of a table and pre-ordering of menu items to be served shortly after arrival at that reserved table according to an embodiment.

### DETAILED DESCRIPTION

The inventor has conceived, and reduced to practice, various systems and methods for predicting restaurant table occupancy in support of optimizing table reservation creation and table usage. The inventor has further conceived and reduced to practice various systems and methods of timing restaurant menu item preparation such that a restaurant patron who has pre-ordered food items will receive the prepared food items shortly after being seated at that table.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

Definitions

As used herein, “host” refers to any male or female employee of a restaurant whose job duties include: taking a restaurant patron's food order at or near the time the patron is seated; bringing the prepared food that has been ordered to the correct restaurant patron for eventual consumption by that patron; polling the restaurant patron for satisfaction opinions and confirm that the patron and their party have vacated the table at the end of their stay. The word also extends to the food preparation staff, managers or administrative staff or any other employees members who may interact with a patron or patrons.

Conceptual Architecture

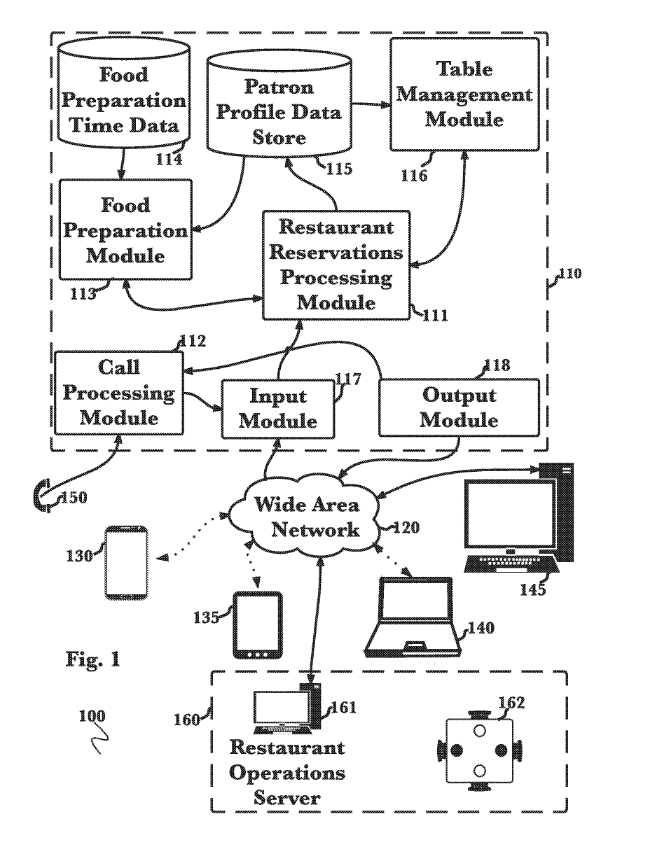

FIG. 1 is a diagram of an exemplary architecture of a system to allow restaurant patrons to reserve a table and order menu items to be served shortly after arrival at the reserved table according to an embodiment 100. Restaurant patrons preferably use the restaurant portal device running on one of their network connected computing devices such as, but not limited to a smart phone 130, tablet 135, laptop 140, or desktop computer 145 to make reservations at that restaurant. The network connection 120 may include but is not limited to the following types: a WiFi local network, cellular wide-area network, short-range wireless interconnection, Ethernet, or other data communication network according to the capabilities or intended use of a particular device. All incoming communications may be aggregated by a centralized input module for category screening normalization purposes 117. These network type examples were chosen partially upon their current prevalence the example should in no way be used to limit the network use capability of the aspect. While using the device, patrons may enter the date and time for which they wish to reserve a table at which time they may be presented with a map of the restaurant showing the tables 162 predicted to be available at the desired time as determined by the table management module 116, which uses the food preparation time data store through the food preparation module to retrieve preparation times for food items ordered at each of the tables of the restaurant, the patron profile data store to determine the food eating habits of known patrons at each table and a generic food consumption time data store (not depicted) to calculate table occupancy periods and, depending on the data present in their and their intended guests' patron profile in the patron profile data store 115, the map may be further coded to highlight specific available tables that may be most appealing to the patron making the reservation and their guests known to the aspect. The patron could then create the reservation by choosing any of the open tables for the desired time. The patron also may elect to pre-order food and drink items for themselves and their guests for the date and time of the reservation from the restaurant portal device's electronic menu to be prepared such that they would be served shortly after the party is seated. At this point, the food preparation module 113 may be consulted to determine whether ingredients in the ordered food matches data in the patron's profile 115 or any of the profiles of that patron's guests known to the system 115 for food allergies or ingredients that those diners are known to strongly dislike. If such information is retrieved, patron may be sent an informational warning. Completion of the reservation process would result in the table being removed from the pool of available tables for a predicted amount of time and a confirmation being sent to the patron from the restaurant reservations processing module 111, 118 through the restaurant portal device 130, 135, 140, 145 running on the patron's phone. Alternatively, the patron may elect to create the reservation by telephone 150. In this situation, calls would be processed by the call processing module 112, which may result in the call being answered by a representative at a centralized call center, an idle host at the restaurant using his or her restaurant provided mobile device or a computerized interactive voice response system. In all cases, the answerer would have complete access to all resources available through the restaurant portal device so that restaurant patrons making reservations with access to a table map could request desirable tables and patrons with access to a menu may pre-order food.

The timing and execution of food preparation so that it is ready shortly after the patron's party is seated is coordinated by the restaurant reservation processing module 111, the food preparation module 1513 and the food preparation time data store 114 which places each menu on the cook list to start at a specific time possibly with a recipe listing ingredients cook times and temperature.

While this particular embodiment shows the preferred network connected configuration 110, 520, 560 with data being displayed by monitors, touchscreens and on workstations 161 at the restaurant 160, this depiction does not imply that the aspect is dependent on that configuration. In fact other embodiments could follow any topology known to those skilled in the art. Also it can be easily seen that the drawn relationships and connections between the components of the system are not always optimal for the roles given to them in the written examples, the diagram is drawn to show the relationships and connections in the most clearly drawn manner and do not always depict the most logically direct mode.

### Detailed Description of Exemplary Aspects

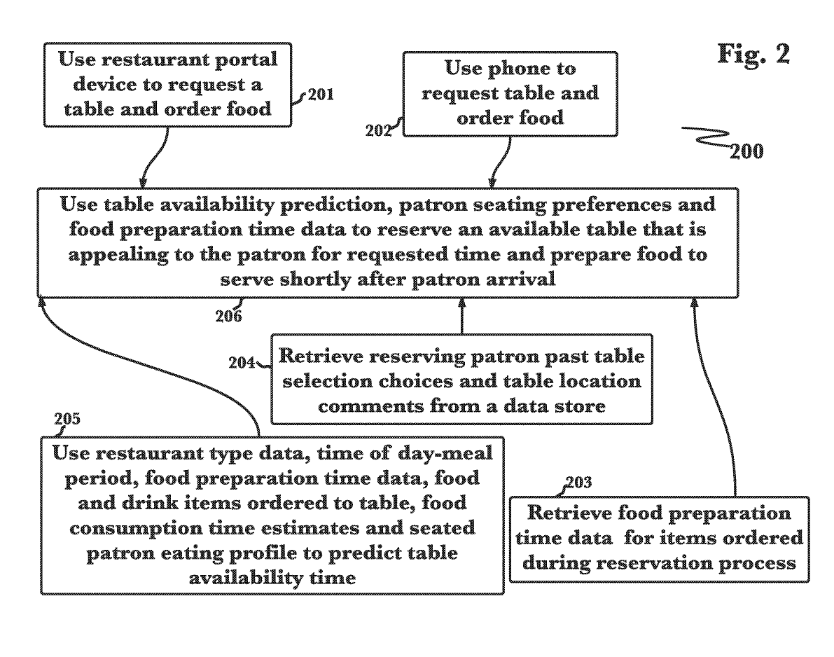

FIG. 2. is a diagram of a method to allow reservation of a table and pre-ordering of menu items to be served shortly after arrival at that reserved table according to a preferred embodiment 200. The aspect accommodates two major types of requests, or reservations, for a restaurant table, the traditional type reservation, where the patron requests a table for specific meal hours to weeks in advance; and a next available table type request, where the patron contacts the restaurant wishing a table, and possibly specific menu item food, as soon as possible from the time of the request. Both types of requests may be received using a restaurant portal device 201, 130, 135, 140, 145 which is part of the aspect and allows tables to be requested and food and drink items to be pre-ordered for arrival at the table shortly after the patron's party is seated. Alternatively, both types of table requests can be made using a phone, the call possibly answered at a centralized call center, through the restaurant supplied mobile devices 141, 142, 143 of hosts at the restaurant who are seen by the system as available for the task, or by a computerized voice response unit, with menu items ordered using a copy of the restaurant's menu in the patron's possession 202, 150, 112. In all request cases, a pool of available tables to fulfill the request is predicted by the aspect by accounting for variables taken from a list of: the restaurant type retrieved from a data store, time of day the request is for time available from the table manager module's system clock 116, the effect of time of day at the restaurant on table occupancy retrieved from a data store (not depicted), food and drink items ordered by the party currently occupying the table, empirically determined mean consumption times and variances obtained from data stores (not depicted), including the patron profile data store 115 if known patrons are occupying the table of interest, preparation time estimates for any currently undelivered menu items as retrieved through the food preparation module 113, among other factors 205. Data concerning the table preferences of the patron requesting the table 115, 204 can also be used, to insure that the incoming patron consistently has the best possible experience. When food items are pre-ordered during creation of the table request, food preparation time estimates 114, 113 for each food item 203, are used to insure that the entire order arrives at optimal temperature shortly after the patron and their guests are seated at their table 206. This method of predictive table assignment also aids in keeping a restaurant at highest capacity while keeping patron arrival-to-seating times low.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

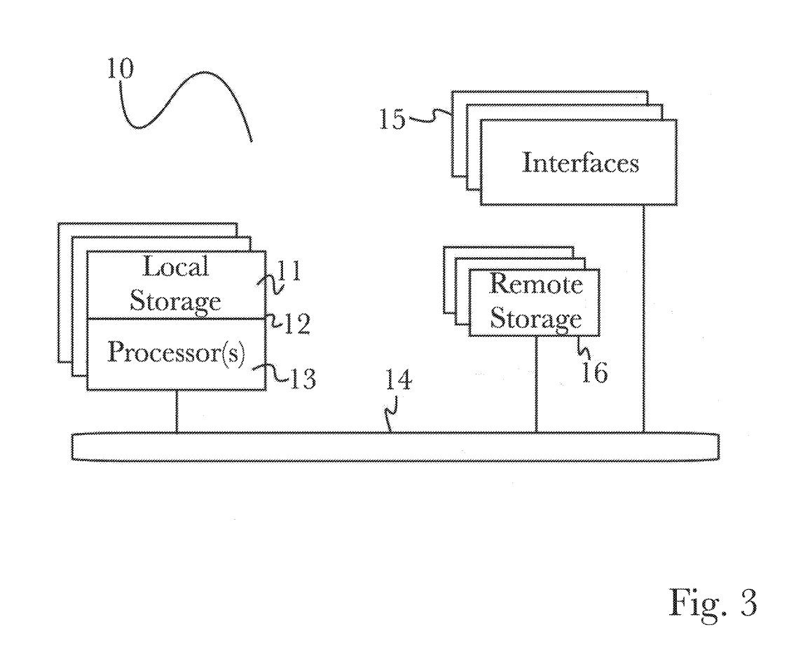

Referring now to FIG. 3, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some aspects, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™ THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 3 illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device aspects may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

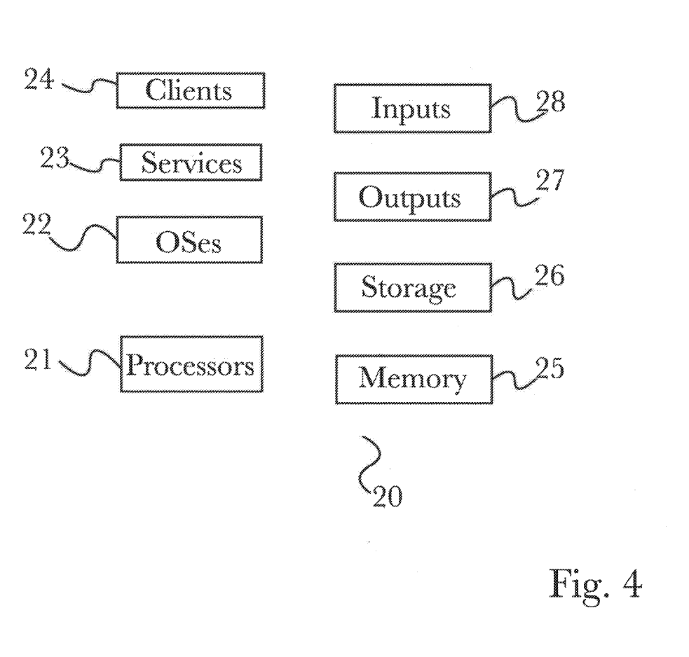

In some aspects, systems may be implemented on a standalone computing system. Referring now to FIG. 4, there is shown a block diagram depicting a typical exemplary architecture of one or more aspects or components thereof on a standalone computing system. Computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE OSX™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 3). Examples of storage devices 26 include flash memory, magnetic hard drive, CD-ROM, and/or the like.

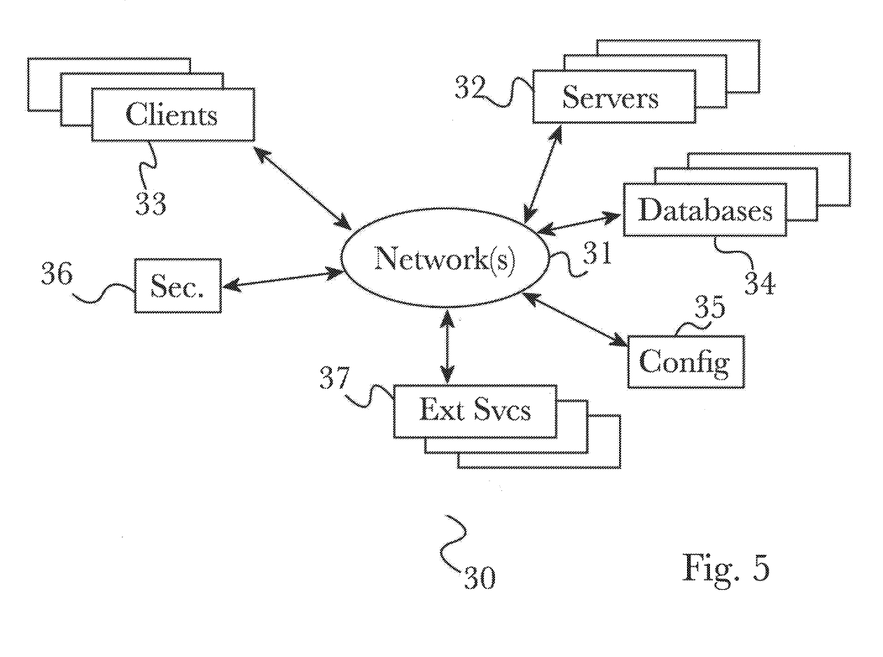

In some aspects, systems may be implemented on a distributed computing network, such as one having any number of clients and/or servers. Referring now to FIG. 5, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 4. In addition, any number of servers 32 may be provided for handling requests received from one or more clients 33. Clients 33 and servers 32 may communicate with one another via one or more electronic networks 31, which may be in various aspects any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises.

In some aspects, clients 33 or servers 32 (or both) may make use of one or more specialized services or appliances that may be deployed locally or remotely across one or more networks 31. For example, one or more databases 34 may be used or referred to by one or more aspects. It should be understood by one having ordinary skill in the art that databases 34 may be arranged in a wide variety of architectures and using a wide variety of data access and manipulation means. For example, in various aspects one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with aspects without limitation, unless a specific security 36 or configuration system 35 or approach is specifically required by the description of any specific aspect.

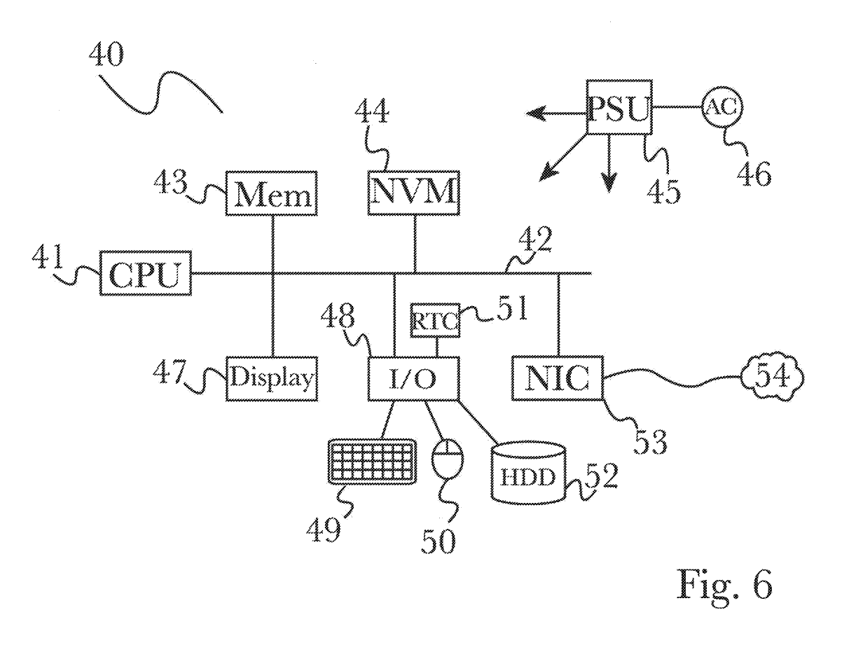

FIG. 6 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various aspects, functionality for implementing systems or methods of various aspects may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various aspects described above. Accordingly, the present invention is defined by the claims and their equivalents.

What is claimed is:

1. A system to allow a restaurant patron to reserve a table and order food items, to be served shortly after seating, comprising:
a restaurant portal device including a memory, an operating system and a processor;
a restaurant reservations processing module stored in a memory of and operating on a processor of a computing device;
wherein, the restaurant portal device:
(a) operates on at least one computing device of the restaurant patron;
(b) acts as an interface between the restaurant patron and a restaurant;
(c) allows the restaurant patron to create a table reservation request;
(d) allows the restaurant patron to place an order of food items;
wherein, the restaurant reservations processing module:
(e) receives the restaurant patron's table reservation request;
(f) retrieves a list of predictively available tables including predicted time point;
(g) assigns a table from the list of predictively available tables to the restaurant patron's table reservation request;
(h) updates the list of predictively available tables to remove the table;
(i) at programmatically predicted time points prior to restaurant patron's arrival, submits the order of food items data for preparation and service shortly after the restaurant patron is seated at the table.

2. The system of claim 1, wherein at least one restaurant patron creates the table reservation request and order the food items using telephony.

3. The system of claim 2, wherein at least one telephone call is answered by an interactive voice response unit.

4. The system of claim 2, wherein at least one telephone call is answered by a dedicated restaurant reservation call center.

5. The system of claim 2, wherein at least one telephone call is answered by a restaurant staff member available at the time of the telephone call.

6. A method to allow a restaurant patron to reserve a table and order food items, to be served shortly after seating, the method comprising the steps of:
(a) using a restaurant portal device including a memory, an operating system and a processor and controlled by a restaurant patron to reserve a restaurant table and to pre-order food items;
(b) employing a list of restaurant tables predicted to be available at the time of the restaurant patron's arrival by a restaurant reservations processing module stored in a memory of and operating on a processor of a computing device to assign restaurant table to the restaurant patron's reservation;
(c) retrieving food item preparation time data for menu items ordered during reservation process into the restaurant reservations processing module; and
(d) using food item preparation time data and requested restaurant table reservation time to coordinate service of pre-ordered food items shortly after the restaurant patron is seated using the restaurant reservations processing module.

7. The method of claim 6, wherein the restaurant patron may reserve the table and order the food items using telephony.

8. The method of claim 6, wherein at least one telephone call is answered by an interactive voice response unit.

9. The method of claim 6, wherein at least one telephone call is answered by a dedicated restaurant reservation call center.

10. The system of claim 6, wherein at least one telephone call is answered by a restaurant staff member available at the time of the telephone call.
